(19) United States
(12) Patent Application Publication
(10) Pub. No.: US 2025/0030265 A1
(43) Pub. Date: Jan. 23, 2025

(54) ELECTRIC VEHICLE CHARGING SYSTEM AND METHOD

(71) Applicant: Voltz Innovations LLC, Lakewood, CA (US)

(72) Inventors: Alexander Campbell, Lakewood, CA (US); Jose Francisco Cardenas Lopez, Lakewood, CA (US); Juan Adolfo Cantu Rodriguez, Lakewood, CA (US); Joey Villareal, Lakewood, CA (US)

(21) Appl. No.: 18/773,901

(22) Filed: Jul. 16, 2024

Related U.S. Application Data
(60) Provisional application No. 63/527,285, filed on Jul. 17, 2023.
(60) Provisional application No. 63/546,718, filed on Oct. 31, 2023.

(51) Int. Cl. H02J 7/14; B60L 53/53; B60L 53/57; H02J 7/34

(52) U.S. Cl. CPC H02J 7/1423; B60L 53/53; B60L 53/57; H02J 7/342; B60L 2200/36

(57) ABSTRACT

A battery charging system configured to be used with a vehicle and that includes an axle having at least a first wheel thereon, a first gear associated with the axle, and a second gear associated with a generator. The belt extends between the first gear and the second gear. The generator is electrically connected to a first battery. Rotation of the first wheel causes rotation of the first gear, the belt and the second gear. Rotation of the second gear causes the generator to charge the first battery. The battery charging system can be used win a method for charging batteries while cargo trucks move between locations to make deliveries.

### CROSS-REFERENCE TO RELATED APPLICATIONS

This application claims the benefit of U.S. Provisional Application No. 63/527,285, filed on Jul. 17, 2023, and U.S. Provisional Application No. 63/546,718, filed on Oct. 31, 2023, the entireties of which are incorporated by reference herein.

### FIELD OF THE INVENTION

The present invention relates to a system for charging batteries and supplying power utilizing moving vehicles.

### BACKGROUND OF THE INVENTION

In the coming decades a large portion of the trucking industry will convert to electrical trucks. The current US infrastructure will have difficulty supporting energy supply to operate the influx of electrical trucks, at which point the price for energy may increase to or exceed the price of diesel fuel to operate conventional trucks. There is therefore a need for a smart charging trailer system and method to decrease or accommodate for electrically operated trucks.

The background description disclosed anywhere in this patent application includes information that may be useful in understanding the present invention. It is not an admission that any of the information provided herein is prior art or relevant to the presently claimed invention, or that any publication specifically or implicitly referenced is prior art.

### SUMMARY OF THE PREFERRED EMBODIMENTS

In accordance with a first embodiment of the present invention there is provided a method of charging batteries that includes moving a first vehicle from a first location to a second location, wherein the vehicle includes at least a first charging battery associated therewith. A charging battery is a battery that will be charged as the vehicle moves between locations based on the rotation of one or more of the wheels on the ground. The first charging battery is charged via the rotation of at least a first wheel as the first vehicle moves from the first location to the second location. The method includes leaving the first charging battery at the second location. The first charging battery (because it is now charged) may be used at the second location to charge a first powering battery. A powering battery is a battery used to power something, such as another vehicle or electric components within a building. The method includes associating a second charging battery with the first vehicle and then moving the first vehicle from the second location to a third location. The second charging battery is charged via the rotation of the first wheel as the first vehicle moves from the second location to the third location. The method may include leaving the second charging battery at the third location, wherein the second charging battery is used at the third location to charge a second powering battery.

The first vehicle may include a charging assembly associated with an axle of the vehicle. The first charging battery may be associated with a first battery assembly that includes a footprint that is approximately the size of a standard pallet footprint. The first battery assembly may be positioned in a trailer interior of a trailer of the vehicle. The trailer interior may include one or more standard pallets therein that include goods being moved from the first location (to be delivered at one of the later locations).

The first vehicle may be a semi-truck that includes a first cab and a first trailer, wherein the first charging battery is associated with a charging trailer that is connected to the first trailer. The first powering battery may be used to charge an electric vehicle or a building (i.e., any electric components in the building). The axle associated with the charging assembly may not have brakes. The axle may include a lift system that is configured to move the axle and first wheel between a first position where the first wheel contacts the ground and a second position where the first wheel does not contact the ground.

In accordance with another aspect of the present invention, there is provided a battery charging system configured to be used with a vehicle. The charging system may include an axle having at least a first wheel thereon, a first gear associated with the axle, and a second gear associated with a generator. The belt extends between the first gear and the second gear, the generator is electrically connected to a first battery, and rotation of the first wheel causes rotation of the first gear, the belt and the second gear, which causes the generator to charge the first battery. The axle may include a torque converter.

The vehicle may be a semi-truck that includes a first cab and a first trailer, wherein the first battery is positioned in a trailer interior of the first trailer. The first battery may be associated with a first battery assembly that includes a footprint that is approximately the size of a footprint of a standard pallet. The vehicle may be a semi-truck that includes a first cab and a first trailer, and the first battery may be associated with a charging trailer that is connected to the first trailer. The vehicle may be a semi-truck that includes a first cab and a first trailer, and the first battery is a powering battery that powers the cab (e.g., the powering battery may be the standard battery of the cab). The first battery assembly may be positioned on a charging track associated with the floor of the trailer.

The present invention includes a power or electricity generation system utilizing a fleet of tractor or semi-truck trailers as they make cargo deliveries to charge external/removable batteries (charging batteries) located onboard each of the tractor trailers. As a tractor trailer moves from its initial or first location to a delivery or second location, one or more batteries onboard the tractor trailer are charged utilizing the rotation of one or more of the truck's wheels, tires, etc. The charged batteries are dropped off at the delivery or second location and may be used to charge (a powering battery) electric vehicles, a building or the like or the power may be delivered to the electrical grid or a local electrical grid. The tractor trailer may pick up another uncharged battery and charge that battery on its way to a third location where the charged battery can be dropped off and used to power electrical components or items as discussed above. In an embodiment of the invention, the batteries may be shaped similarly to or have the footprint of a pallet, thus allowing batteries to fill unused cargo space within a trailer. Lastly, the system may be deployed utilizing other vehicles, such as trains, buses, etc. It will be appreciated that the charging system, including the generator, etc. may be used to charge a charging battery for later use with something other than the semi-truck or tractor trailer on which it is traveling and being charged, or the charging system may be used to charge a battery that is electrically connected to the motor or in some way associated with the vehicle on which the battery is traveling, so that the range of the semi-truck may be extended. In other words, the rotation of the wheels and the associated charging system may be used to extend the distance that could be traveled without the charging system or provide an additional charge, assistance or supplemental charge, while moving or traveling.

The present invention may use generators onboard semi-truck or trailers that generate and then store electricity while the semi-truck moves from one location to another. The standard generator head may be 80 inches long and 30 inches in diameter. The standard generator produces about 75 kWh at 40 horsepower, and weighs approximately 500 pounds. One of ordinary skill in the art would understand that these are only one of a variety of specifications for standard generators and the numbers may vary depending upon the generator described. Furthermore, any dimensions, values, numbers, specifications and the like discussed or disclosed herein are merely exemplary and are not limitations on the present invention. The standard generator head may include a fixed outer housing and an axle or free-rotating shaft. In operation, the free-rotating shaft rotates within the fixed outer housing to generate electricity. One of ordinary skill in the art would understand that both DC and AC generators are within the scope of the present invention. For example, an alternator is generally configured to convert mechanical energy into AC electrical energy. A generator is generally configured to convert mechanical energy to either AC or DC electrical energy.

The smart charging trailer generator/alternator head, in contrast, may be 102 inches long (approximately the width of the trailer) and has a diameter of 10 inches. In an embodiment, the length and diameter may vary within a range of approximately 1-5 inches in width and 2-3 inches in diameter. In other embodiments, the length of the generator/alternator head is shorter to accommodate two or more generators/alternators across the width of the trailer, or a single generator/alternator across the width of the trailer that does not extend the entire 102 inch width of the trailer. A generator may produce one hundred to two hundred kWh at ten horsepower and weigh approximately the same as the standard generator shown above. The smart charging trailer generator/alternator head may include a fixed center rod and an outer housing. In an exemplary generator/alternator, the center rod may be welded and fixed, while the outer housing may be rotatably attached such that it freely rotates about the center rod.

The generator/alternator of the smart charging trailer may be configured to be affixed to approximately the same area as a standard generator, as discussed herein. The generator/alternator in a preferred embodiment may utilize one or more permanent magnets or other types of generators (pending the specification and/or requirements of EV manufacturers) to produce three hundred to six hundred kilowatts per hour to charge the electrical truck battery during operation. The generator/alternator technology preferably operates at sixty to four hundred Hz, at a voltage of six hundred to seven hundred volts, at an RPM of one thousand to eight thousand RPMs. In an embodiment, the generator/alternator weighs less than 600 kilograms and produces thirty-three hundred and fifty kilowatts per hour. The generator/alternator is custom configured to utilize components to achieve low torque/horsepower requirements to turn. The smart charging trailer system is intended to produce high-output power utilizing low-force or light-force (e.g., “zero” force as used throughout the industry) generators to take advantage of rotational energy from the semi-truck/trailer's axles. The battery is preferably a 100,000 amp battery. It will be appreciated that any dimensions, units, sizes or other numbers given or discussed herein are only exemplary and are not limiting on the present invention.

In a preferred embodiment, the gears may be configured to be magnetic gears such as those provided by Magnomatics. The magnetic gears are configured to operate with very little or minimal resistance allowing for higher efficiency in operation. Using magnetic fields of powerful magnets, the magnetic gears may operate without requiring wearing parts, achieving less friction and power required to turn the gears. The systems may include three rings that are angularly displaced about the center axis. The first ring and second ring may include magnets in an alternating north-south pattern. The first ring may include a lower number of magnet sections, and the second ring may include a larger number of magnetic sections. The third ring may include steel segments which alter the magnetic field between the first ring and the second ring. The first ring is connected to a high-speed shaft and the third ring is connected to a low-speed shaft. The second ring may be held stationary and integrally connected with the outer ring/housing. The high-speed shaft may be connected to a first gear configured to rotate at a high speed. The low-speed shaft may be connected to a second gear configured to rotate at a low speed (e.g., lower speed than the speed at which the first gear rotates). The first ring and the third ring are not physically touching and are separated by an air gap caused by the magnets of the first ring. So, too, the second ring and the third ring are not physically touching and are separated by an air gap caused by the magnets of the second ring. The third ring and its steel segments modifies the magnetic field between the first ring and the second ring so that the first ring rotates at a higher speed, and in an opposite direction, of the second ring. Along with the high-speed shaft, the first ring, the second ring, the third ring, the low-speed shaft, and the outer ring/housing, there may be a first collar ring, a first cap securing the first collar ring and the high-speed shaft and/or first gear, a second collar ring, and a second cap securing the second collar ring and the low-speed shaft and/or second gear. In an alternate configuration, stators are included affixed to the outer ring/housing. In this configuration, the third ring is driven at a lower speed than the first ring, thereby creating a generator/motor effect and efficiently driving the third ring, and thus, the high-speed shaft/first gear at a high speed.

In a preferred embodiment, static electricity may be generated using, for example, a Wimhurst Machine or Van de Graff generator. The generator is preferably configured with a belt for rotating the outer part of the generator, which produces high voltage. Thus, when using AC/DC converters, the static belt may compensate for loss of voltage. Consequently, the Wimhurst Machine/Van De Graff generator, along with the generator/alternator, are utilized to produce power.

The smart charging trailer system and method also may include an array of sensors, recording devices or other components, including cameras, motion sensors, microphones, GPS, air quality control sensors, IR ground measuring sensors, LiDAR, solar panels all configured to operate via one or more apps or application and operate as a part of the system. In an embodiment, the IR ground measuring sensor detects and/or warns the driver of black ice conditions. The array of sensors in a preferred embodiment is sufficient to satisfy semi-autonomous (self-driving) vehicle standards. For example, the standards may include, but are not limited to, AEC-Q100 and/or AEC-Q200 standards. The solar panels are affixed to the trailer to provide operational power to the smart charging trailer system and any excess energy will be utilized to charge the electrical truck battery or any batteries carried on board for use at remote locations (e.g., the pallet batteries described herein). In a preferred embodiment, the solar panels may be affixed to the side(s), top, rear or front of the smart charging trailer, truck and/or vehicle.

In a preferred embodiment, the trailer may be equipped with five cameras-two side cameras affixed to the front side roof, two rear cameras attached to top roof corners, and a camera affixed internally in the trailer. The trailer is also equipped with four to six motion sensors for parking and warning/distance notifications. However, any number of cameras or motion sensors (e.g., 1-100) are within the scope of the present invention. The GPS is configured to track the location of the trailers.

In a preferred embodiment, the trailers include smart doors with locks on the inside and a keypad on the outside. Preferably the trailer smart doors are configured to open and lock via an application. The app and smart doors are preferably configured to be operated using Bluetooth or suitable communication network and/or a spare key. The semi-truck may also include the ability to open the cab or trailer using an app. This provides full custody and control to a desired party and may prevent entry by thieves or other unwanted parties. The present invention may also include security drones that are deployed if a notice is given or provide that a semi-truck or vehicle is being pursued by or approached by thieves or other undesired or unauthorized parties. In this scenario, one or more drones or other aircraft are deployed to follow and monitor the thieves and to provide information, such as location, to law enforcement. The notification to deploy the drones may be initiated if the truck or trailer is opened or otherwise entered without permission. The driver may also provide the notice (e.g., via an app, etc.). Cameras on the truck or vehicle (inside and/or out) may also be deployed as desired.

In an embodiment, the sensors may be configured to count cars that have passed the smart charging trailer per trip, or in total. Other metrics are within the scope of the present invention. The application is configured to provide maps, location data, amount of charge the smart charging trailer is producing, total miles traveled (by trailer), status of the smart doors (e.g., open/locked configurations), direction the smart charging trailer is facing, status of the motion/parking sensors, the speed/RPM of the generator/alternator, theft notifications, tire pressure, weight (including payload weight), jackknife warning, air quality, and the like. An exemplary application display may show the current charging rate (e.g., 600 kW/Hr), the gear, the mileage, the speed, warning sensors, tire pressure, cars passed (this trip), a map, and multiple camera feeds at various points around the trailer. In a preferred embodiment, the trailer includes a side screen for advertising. The side screen is preferably integrated with the application to facilitate display of advertisements. The advertisements can be stored on a cloud system and provided to the application/side screen using the internet. The tail portion of the trailer may include integrated steps and may be configured to house portions of the smart charging trailer equipment used for charging the battery.

The present invention is directed to a battery charging system that utilizes moving vehicles, such as trailers, trucks, cars, trains, buses to charge batteries that can later be used as a power source to charge or recharge the batteries associated with electric vehicles, trucks, cars, buildings, homes, warehouses, etc. The present invention is also directed to a system and method of providing battery charging locations, depots, or the like.

In a preferred embodiment, the present invention includes a power or charging system that includes moving a first vehicle that includes at least a first charging battery associated therewith from a first location to a second location. The first charging battery is charged via the rotation of one or more of the wheels as the first vehicle moves from the first location to the second location. Leaving the first charging battery at the second location. The first charging battery may then be used at the second location to power or charge a first powering battery. It will be appreciated that the “charging batteries” are the batteries that move onboard with vehicles between different locations and that are charged as them move from location to location and are then later used to provide power to other things, components, buildings, vehicles, batteries, etc., as desired. The “powering batteries” are the batteries associated with the things, components, buildings, vehicles, etc. that are powered by the charging batteries. The system also includes associating a second charging battery (a pallet battery, a battery in a model G, etc.) with the first vehicle, and moving the first vehicle from the second location to a third location. The second charging battery is charged via the rotation of one or more of the wheels as the first vehicle moves from the second location to the third location. Leaving the second charging battery at the third location. The second charging battery is used at the third location to power or charge a second powering battery. This process may be repeated as desired.

The first vehicle includes a charging system associated with at least one of the axles of the vehicle. The first charging battery may be associated with a first battery assembly (pallet battery) that includes a footprint that is approximately the size of a footprint of a standard pallet. The first battery assembly may be positioned in a trailer interior of a trailer of the vehicle. In a preferred embodiment, the trailer interior includes one or more standard pallets therein that include goods being moved from the first location to a second location. The goods are unassociated with and separate from the pallet batteries. The first vehicle may be a semi-truck that includes a first cab and a first trailer. The first charging battery is associated with a charging trailer that is connected to the first trailer. The first powering battery may be used to power or charge an electric vehicle, a building or the like. U.S. Publication No. 2018/0312206 is incorporated by reference herein in its entirety.

The present invention may be described as a method that includes moving a first vehicle from a first location to a second location, where the vehicle includes at least a first charging battery associated therewith, and where the first charging battery is charged via the rotation of one or more of the wheels as the first vehicle moves from the first location to the second location, leaving the first charging battery at the second location, where the first charging battery is used at the second location to power or charge a first powering battery, associating a second charging battery with the first vehicle, moving the first vehicle from the second location to a third location, where the second charging battery is charged via the rotation of one or more of the wheels as the first vehicle moves from the second location to the third location, and leaving the second charging battery at the third location, wherein the second charging battery is used at the third location to power or charge a second powering battery.

In a preferred embodiment, the first vehicle may include a charging assembly associated with an axle of the vehicle. The first charging battery may be associated with a first battery assembly that includes a footprint that is approximately the size of a footprint of a standard pallet, and the first battery assembly is positioned in a trailer interior of a trailer of the vehicle. The trailer interior may include one or more standard pallets therein that include goods being moved from the first location to a second location. The battery assemblies may be placed on a standard pallet, as is shown in some of the drawings or the battery assemblies may include openings or tunnels defined therein that allow a forklift to load them into the trailer. In other words, the battery assemblies may include the pallet unitary therewith. The first vehicle may be a semi-truck that includes a first cab and a first trailer and the first charging battery may be associated with a charging trailer that is connected to the first trailer. The first powering battery may be used to power or charge an electric vehicle, a building or the like. In an embodiment, the axle may not include brakes and is only associated with the charging assembly. The axle may include a lift system that can move the axle and any wheels associated with the axle between a first position where the wheel(s) contact the ground and a second position where the wheel(s) do not contact the ground.

### BRIEF DESCRIPTION OF THE DRAWINGS

FIG. 1 is a side elevational view of a trailer that includes a charging system in accordance with a preferred embodiment of the present invention;

FIG. 2 is a perspective view of a trailer axle that includes a charging system;

FIG. 3 is a perspective view of the underside of a trailer that includes a charging system;

FIG. 4 is a side elevational view of a trailer that includes a series of charging systems;

FIG. 5 is a side elevational view of a trailer showing a battery associated with a charging system;

FIG. 6 is a bottom plan view of a portion of a trailer with a charging system;

FIG. 7 is a perspective view of a portion of a trailer that includes a charging system;

FIG. 8 is a schematic view of a truck and trailer that includes a plurality of pallet batteries in the storage portion of the trailer;

FIG. 9 is a perspective view of a trailer with a charging system, pallet battery and charging tracks therein;

FIG. 10 is a perspective view of a forklift loading pallet batteries into a trailer;

FIG. 10A is a perspective view of a pallet battery;

FIG. 11 is a side view of a charging system trailer with a portion of the charging system located in the wheels;

FIG. 12 is a perspective view of the back portion of a trailer towing a charging trailer;

FIG. 13 is shows a truck recharging using a charging trailer;

FIG. 14 is a flow chart showing recharged batteries being used to power a building;

FIG. 15 is a side elevational view of a trailer that includes a charging system axle in accordance with a preferred embodiment of the present invention; and

FIG. 16 is a side elevational view of a portion of the trailer of FIG. 15 with the charging system axle raised off of the ground.

Like numerals refer to like parts throughout the several views of the drawings.

### DETAILED DESCRIPTION OF THE PREFERRED EMBODIMENTS

The following description and drawings are illustrative and are not to be construed as limiting. Numerous specific details are described to provide a thorough understanding of the disclosure. However, in certain instances, well-known or conventional details are not described in order to avoid obscuring the description. References to one or an embodiment in the present disclosure can be, but not necessarily are references to the same embodiment; and, such references mean at least one of the embodiments. If a component is not shown in a drawing then this provides support for a negative limitation in the claims stating that that component is “not” present. However, the above statement is not limiting and in another embodiment, the missing component can be included in a claimed embodiment.

Reference in this specification to “one embodiment,” “an embodiment,” “a preferred embodiment” or any other phrase mentioning the word “embodiment” means that a particular feature, structure, or characteristic described in connection with the embodiment is included in at least one embodiment of the-disclosure and also means that any particular feature, structure, or characteristic described in connection with one embodiment can be included in any embodiment or can be omitted or excluded from any embodiment. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others and may be omitted from any embodiment. Furthermore, any particular feature, structure, or characteristic described herein may be optional. Similarly, various requirements are described which may be requirements for some embodiments but not other embodiments. Where appropriate any of the features discussed herein in relation to one aspect or embodiment of the invention may be applied to another aspect or embodiment of the invention. Similarly, where appropriate any of the features discussed herein in relation to one aspect or embodiment of the invention may be optional with respect to and/or omitted from that aspect or embodiment of the invention or any other aspect or embodiment of the invention discussed or disclosed herein.

The terms used in this specification generally have their ordinary meanings in the art, within the context of the disclosure, and in the specific context where each term is used. Certain terms that are used to describe the disclosure are discussed below, or elsewhere in the specification, to provide additional guidance to the practitioner regarding the description of the disclosure. For convenience, certain terms may be highlighted, for example using italics and/or quotation marks: The use of highlighting has no influence on the scope and meaning of a term; the scope and meaning of a term is the same, in the same context, whether or not it is highlighted.

It will be appreciated that the same thing can be said in more than one way. Consequently, alternative language and synonyms may be used for any one or more of the terms discussed herein. No special significance is to be placed upon whether or not a term is elaborated or discussed herein. Synonyms for certain terms are provided. A recital of one or more synonyms does not exclude the use of other synonyms. The use of examples anywhere in this specification including examples of any terms discussed herein is illustrative only, and is not intended to further limit the scope and meaning of the disclosure or of any exemplified term. Likewise, the disclosure is not limited to various embodiments given in this specification.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions, will control.

It will be appreciated that terms such as “front,” “back,” “top,” “bottom,” “side,” “short,” “long,” “up,” “down,” “aft,” “forward” and “below” used herein are merely for ease of description and refer to the orientation of the components as shown in the figures. It should be understood that any orientation of the components described herein is within the scope of the present invention.

The present disclosure is directed to a smart charging trailer system and method. The accompanying drawings illustrate various preferred embodiments in accordance with the present invention. It will be appreciated that any type of vehicle that includes rotating wheels and/or one or more rotating axles or other component may be utilized in the present system and invention. It will be appreciated that the use of semi-trucks and/or trailers in the present description and disclosure is only exemplary and should not be construed as limiting.

Using the rotating motion of semi-trailer wheels and axles, the smart charging trailer system and method utilizes the rotation of the wheels to propel generators/alternators to generate electrical power to be stored in batteries carried on or stored in semi-trucks or trailers or used by the batteries needed to operate the electrical trucks.

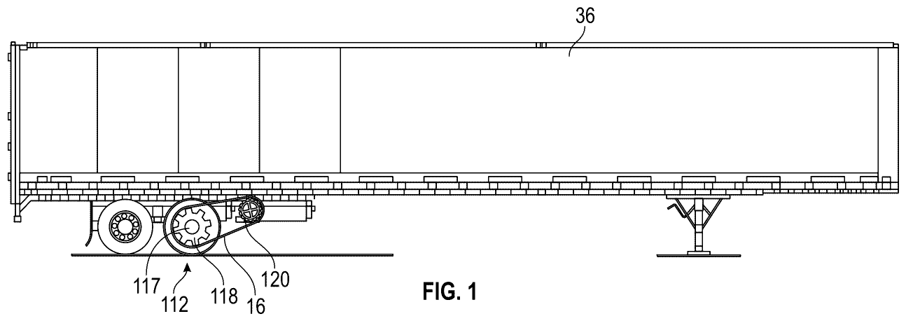

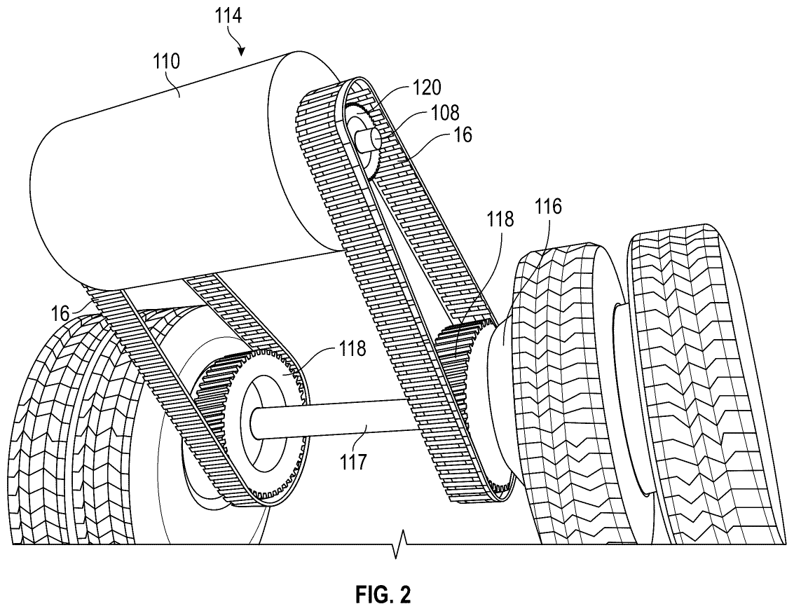

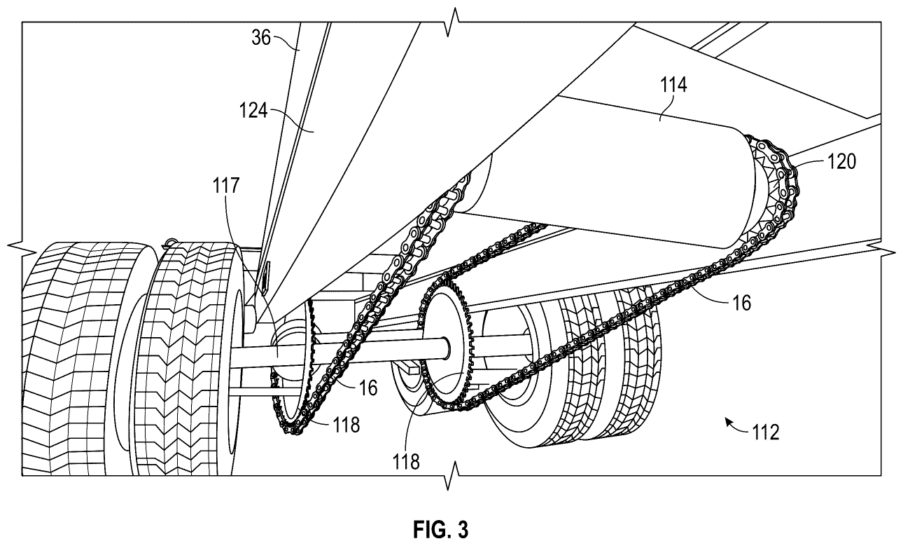

In a preferred embodiment, the smart charging trailer system may include gear ratios and torque converters to increase horsepower and RPMs affixed to the wheelbase and axles. For example, the gears may use a four to one gear ratio in combination with torque converters to achieve horsepower and RPM requirements to operate the generator/alternator in preferred ranges, as disclosed. FIG. 1 shows an exemplary semi-truck trailer 36 with a gear 118 associated with one of the two rear axles (or wheels on the axle 117) and a smaller gear 120 that associated with the generator 114. The smart charging trailer system 112 includes one or more generators/alternators 114, a torque converter 116, a large gear 118, and a small gear 120. In this embodiment, the large gear 118 has been associated with the existing axle of the semi-truck trailer. FIGS. 2 and 3 show an exemplary configuration of the gears (e.g., large gears 118 and small gears 120), torque converter 116, and generator 114 in accordance with preferred embodiments of the present invention. Two belts or chains 16 are also shown and that extend between the gears.

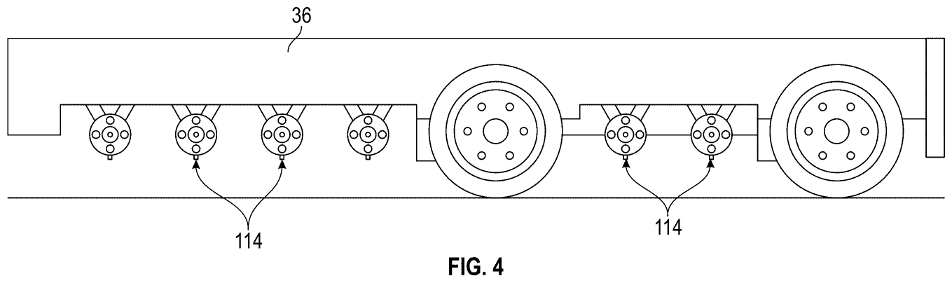

FIG. 4 shows a semi-truck trailer with a smart charging trailer system 112 that includes multiple sub-systems, thus illustrating a four-to-one gearing ratio (e.g., 80 teeth at 1000 RPM; 20 teeth at 4000 RPM) including multiple generators 114 to achieve, for example, 360 kilowatts per hour energy generation (e.g., 12 generators at 30 kWh each). Six generators are shown and six others may be included on the other side of the trailer. The gearing ratio is configured to spin the generator at a faster RPM than that of the axle. As shown in FIG. 2, a larger drawing of the generator/alternator 114 is shown, including the center rod 108 and the outer housing 110. The generator/alternator 114 is shown as an AC generator/alternator. In an embodiment, the axles 117 are custom-made axles configured to operate with the generator/alternator. The torque converter 116 may be a type of fluid coupling that transfers rotating power from a prime mover, like an internal combustion engine, to a rotating driven load. Here, the torque converter 116 is transferring rotating power from the wheel/axle to the gear assembly configured to turn the generator/alternator.

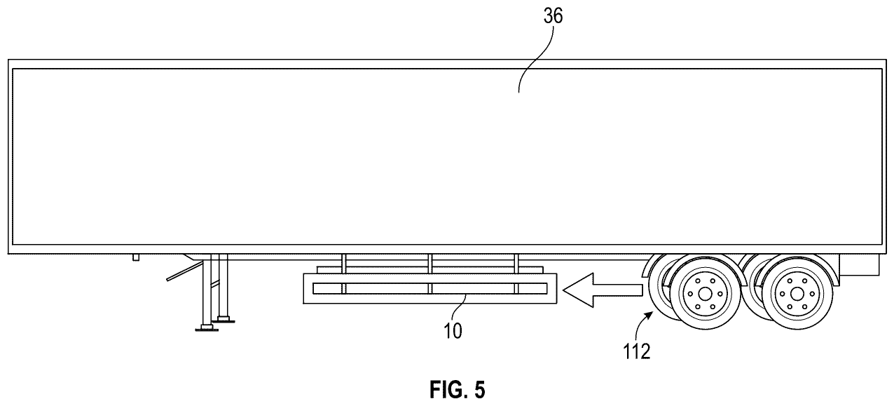

FIG. 5 is a drawing showing a smart charging trailer system in accordance with a preferred embodiment of the present invention. The trailer 36 is designed to charge one or more batteries 10 as the trailer travels from location to location, including interchangeable or removable batteries. As described herein, the use of the batteries that are charged by the system may be to put power onto the electrical grid, charge other batteries (e.g., at a designated charging location or via a charging trailer, as discussed further herein) and/or provide charging for other batteries (e.g., a battery on or in another vehicle). For example, a vehicle, semi-truck or the like (gas, diesel or electrical) may pull, charge, and drop off one or more batteries 10 at a remote location, warehouse, designated charging location, power plant or other location, in an exemplary embodiment, the low force rotation generator/alternator is configured to charge the interchangeable battery 10 and operates at, for example, three thousand to six thousand RPM, producing two hundred to three hundred and fifty kWh at six hundred to seven hundred volts.

In a preferred embodiment, the present invention includes and is directed to a system for providing power or energy via vehicles, such as semi-trucks, that charge onboard batteries as they move from at least a first location to a second location. The semi-truck may include a generator or system for generating energy to charge the one or more onboard batteries. For example, the generator(s) may be integrated into an axle of the truck or trailer of the semi-truck, as described herein above and/or the generator(s) may be associated with a separate trailer (referred to as a charging trailer) that is hauled or pulled by the trailer of the semi-truck that is utilized for hauling goods.

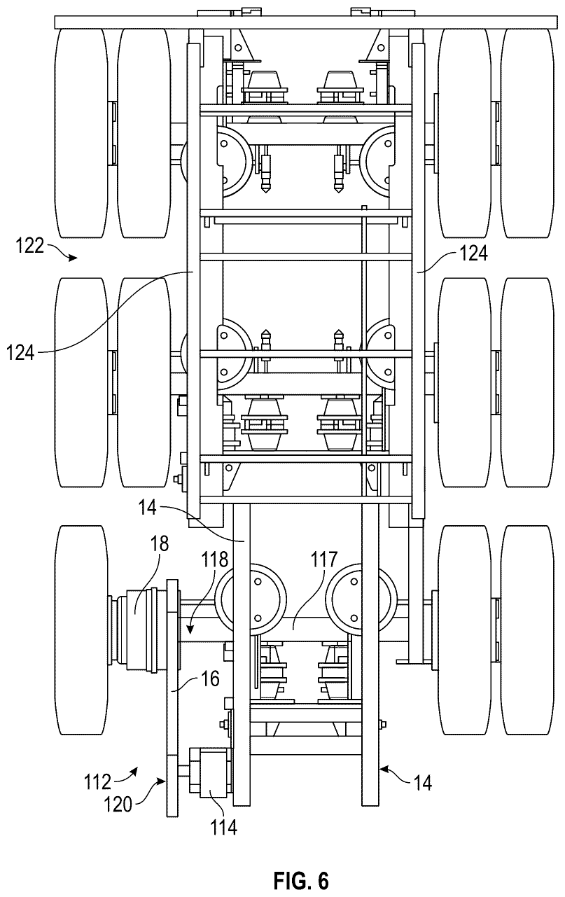

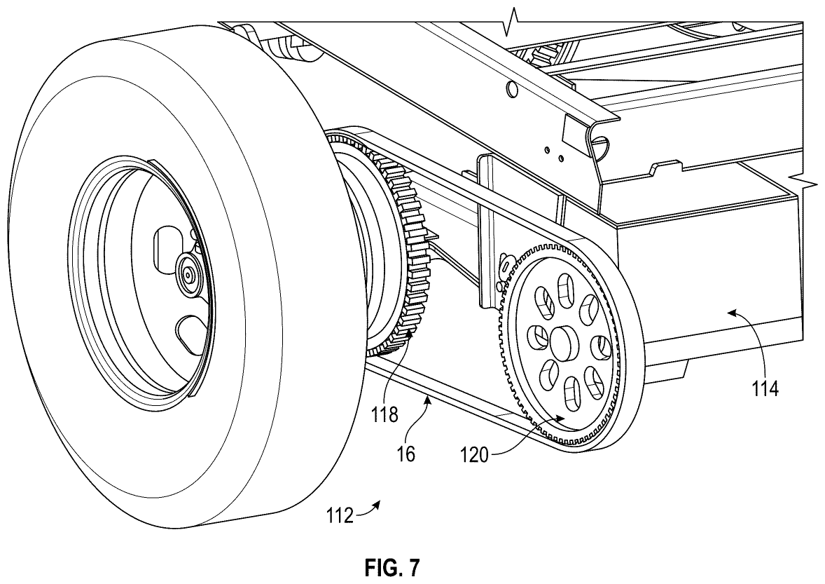

FIG. 6 shows a top view of the chassis 122 of the semi-truck trailer with a wheel removed to provide space for the inclusion of the smart charging trailer system 112. The area where the axle 117 associated with the smart charging trailer system 112 includes narrower rails 14 than the rails 124 associated with the other axles (e.g., the typical two rear axles on a semi-truck trailer). As shown in FIGS. 6-7, a timing belt 16, chain or other connection member that allows rotation of on gear to be transmitted to the other gear (all are generically referred to herein as a belt) may extend between the gears 118, 120. At least one of the gears (e.g., gear 118) may be a one-way slip bearing gear. However, this is not a limitation. Therefore, when the wheel or wheels stop the gear keeps spinning so the generator 114 does not immediately stop, and it provides more rotation even after the trailer stops. As shown in FIG. 6, component 18 may be the inner rim 18 of the tire that has been removed or omitted and may be a mounting location for gear 118. The smart charging trailer systems described herein may be described as Port One or as an at least partially rechargeable chassis for EV semi-trucks designed to extend the range for port to port deliveries.

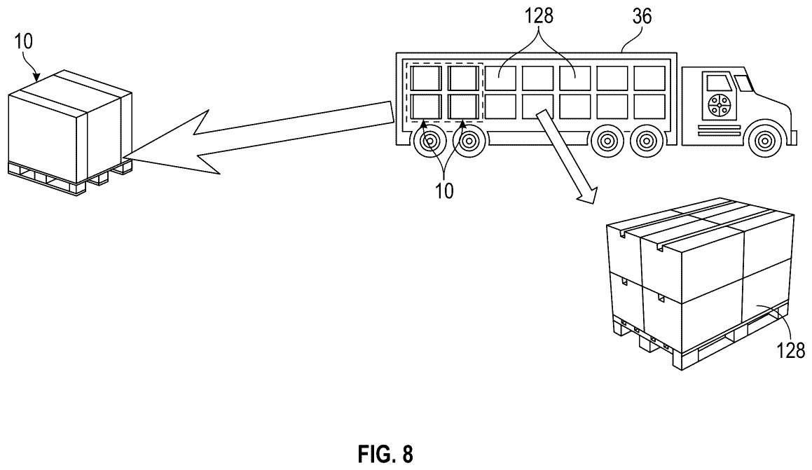

With reference to FIGS. 8-10A, it will be appreciated by those of ordinary skill in the art that in the freight shipping or hauling industry, a large amount of freight (e.g., up to 80% of freight) is hauled in a trailer 36 that is only partially filled with goods for delivery or as referred to in the art as Less-Than-Truckload (LTL). The unfilled volume within an LTL is essentially wasted space. An LTL provides space or volume within the trailer for including batteries 10 that can be hauled from one location to another and may be charged along the way. One or more batteries may be connected to one or more generators that generate power via the rotation of the wheels along the route. Therefore, the batteries can be charged while a semi-truck or other vehicle travels a route that it would be traveling anyway to deliver its freight (e.g., to a warehouse). The present invention utilizes available space within a semi-truck and includes the batteries as a part of the payload, therefore using existing routes to charge the batteries 10 contained within the trailer 36.

In a preferred embodiment, the batteries 10 may be a part of what is referred to herein as a “pallet-sized battery,” which provides efficiency and simplicity when loading and filling the empty space remaining within a semi-trailer. See FIG. 8, which shows the trailer 36 of a semi-truck loaded with ten pallets of goods 128 toward the front of the trailer and four pallet-sized batteries 10 in the back (marked by a dashed box).

In a preferred embodiment, a pallet-sized battery or battery assembly 10 is a second life recycled EV battery that has approximately the same footprint of a standard pallet (e.g., the standard pallet size in the United States is 48 inches×40 inches) and approximately the same height as a standard sized fully loaded pallet as is known in the freight industry. The battery assembly 10 is sized and utilized to fill space when available within a semi-truck that is being used to deliver cargo from one location to another. During the trip between locations, the battery assembly 10 is connected to the trailer's generator (e.g., the generators 114 associate with one or more axles of the trailer). In an exemplary embodiment, the battery assembly (which may include a number of batteries) is able to be charged up to 1 kw per mile and a full charge may be reached after about 1,000 miles. Most freight deliveries are made from one warehouse to another, and the average warehouse uses four thousand to five thousand KW per month. Therefore, for example, four to five pallet-sized batteries per month (that were delivered fully charged together with a regular delivery) may charge an average warehouse for a month. This reduces the amount of access to grid energy that is necessary. It will be appreciated that all batteries labeled 10 herein are batteries that have been charged via the movement of a vehicle from a first location to a second location.

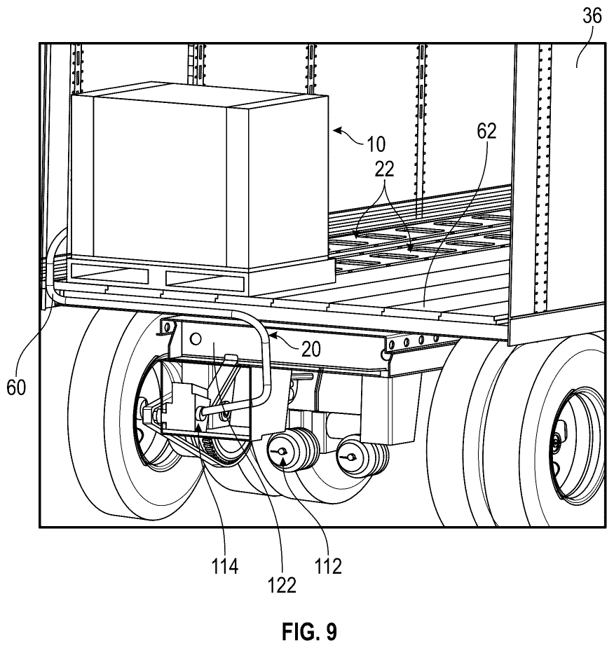

FIG. 9 shows an embodiment of the battery assembly or pallet-sized batteries 10 and their exemplary implementation in or associated with semi-trucks or a semi-truck trailer 36. It will be appreciated that any type of generator for generating energy as the semi-truck moves from location to location is within the scope of the present invention. The generator may be part of the smart charging trailer system 112 discussed and show herein or may be any type of generator. The generators generally may be referred to or labeled in the figures as generator 114.

As shown in FIG. 9, in a preferred embodiment, a cable or cord 20 electrically communicates the smart charging system 112 (e.g., generator 114) and one or more battery assemblies 10 housed in the trailer interior. The cord 20 may extend through openings 60 in the floor 62 of the trailer 36 or may extend between the floor 62 and chassis 122. The electrical connection between the smart charging system 112 and the battery or batteries 10 housed in the trailer interior allows charging of the batteries as the semi-truck travels along its route.

In a preferred embodiment, the trailer may include a system for electrically connecting the battery assemblies 10 so that multiple battery assemblies 10 can be charged simultaneously and by a single cable 20 extending from the smart charging system 112 (or multiple cables). For example, a system of rails 22, plates or the like may be included in the trailer interior and the battery assemblies 10 may be electrically connected to the rails 22 or plates, such that the electrical connection extends from the cord 20 to the rails 22, plates, etc. and to the batteries. This charging system may be implemented so that when the battery assembly is 10 are loaded, they are connected to the rails or plates and are then in a charging position or orientation. For example, see rails 22 in FIG. 9 that extend longitudinally along the floor of the trailer. The battery assemblies 10 can also be configured such that when they are stacked on top of one another they are electrically connected to one another so that they are part of the charging system. The battery assemblies 10 and the charging system may include complementary charging connections that allow charging. For example, they may include connections like Legos that allow easy stacking and connection. The charging system may allow connection of the cable or cord 20 or other electrical connection from the smart charging system 112 to a first battery assembly 10, which is then electrically connected to one or more further battery assemblies, therefore, providing charging to all of the connected battery assemblies 10 within the trailer. The charging system may include magnets. For example, the entire floor or a portion of the floor or surface of the trailer may include magnets such that when a battery assembly 10 is positioned thereon on or thereabove, the battery assembly is charged (similar to how a mobile phone may be charged wirelessly by being placed on a charging surface). The charging system may also include some type of plug connection where each battery assembly is plugged into or connected to the rail or plate system.

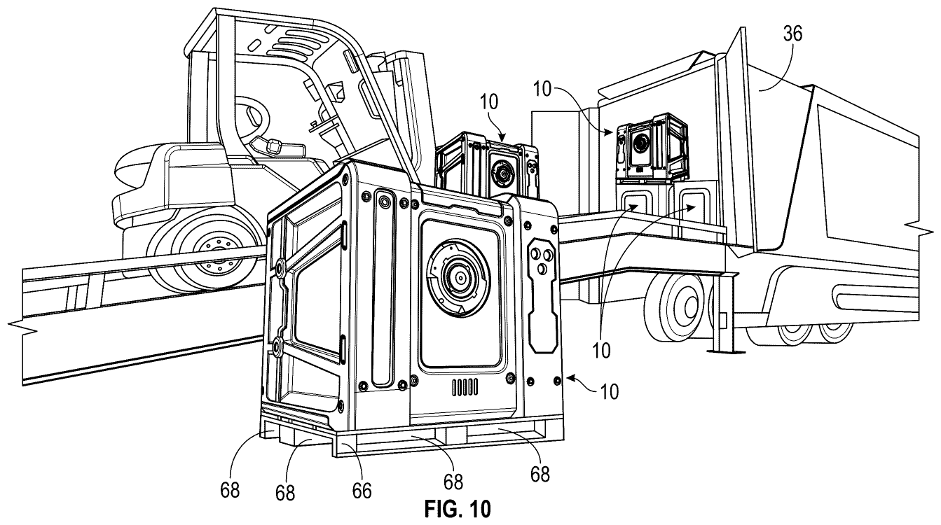

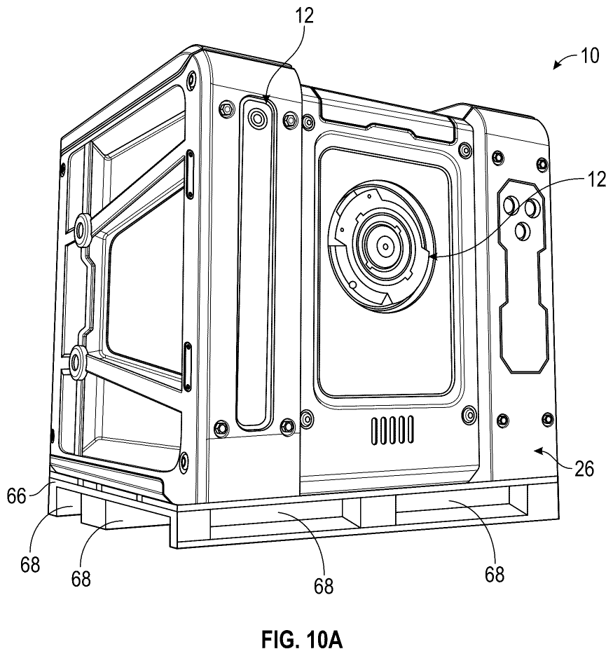

FIG. 10 shows battery assemblies 10 stacked on top of one another in the rear of a trailer 36 and another being loaded into a trailer by a forklift. FIG. 10A shows a close up of an exemplary pallet battery 10. It will be appreciated that the pallet portion 66 or the portion that includes fork lift openings 68 may be a standard pallet on which the battery is placed or the pallet portion 66 may be integrated with or unitary with the battery assembly 10.

In a preferred embodiment, the battery assembly 10 includes ports, jacks, plugs or any capability for connecting cords or the like to both charge the battery within the battery assembly and use the battery assembly to charge external devices, such as EV trucks, cars, a warehouse, building, etc. FIG. 10A shows some of these ports 12. The type of battery is not a limitation on the invention. For example, the batteries may be lithium-ion or nickel-based batteries. A ventilation system (e.g., including fans), fire extinguishing system (to prevent overheating) may also be included as part of the battery assembly. The fire extinguishing system may emit foam, liquid or other substance if a fire is detected within the battery assembly. The ventilation or cooling system may include tubing, piping or the like (that may be part of a housing 26) for cooling the batteries therein as they charge.

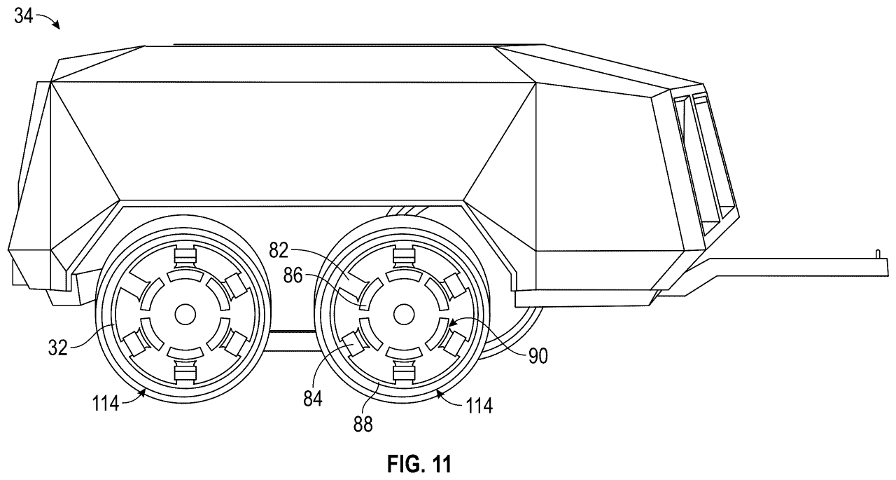

In another preferred embodiment, the generator 114 or other portions of the smart charging system 112 may be housed within One or more of the wheels or rims of the trailer or truck. FIG. 11 shows a trailer 34 where opposing rims 32 and tires on opposite ends of an axle include some of the components of the generators 114, including magnets and coils 30. The inside of the rims include magnets opposing those shown on the axle. FIG. 11 shows the coils in the rim interior. These generators 114 are then electrically connected to the battery assemblies housed in the trailer.

FIG. 11 is directed to an embodiment of a charging trailer 34 that may be used in military applications and where the generators 114 are housed within are a part of the rims 32 or wheels of the charging trailer 34. As shown in FIG. 11, the generator 114, may include stators, (stator teeth 82, stator windings/coils 84), magnets 86, yokes 88 and an air gap 90 between components. The components can be reversed from what is shown in FIG. 11. The generators 114 may be included in one or more of the rims and are electrically connected or communicated with batteries on board or within the trailer 34. The batteries are charged as the trailer 34 is towed, e.g., by a military vehicle. In use, the charging trailer 34 and the batteries therein may be used to power, for example, a mobile command center or other location used or desired by the military or other user of the trailer. Generators may also be included on one or more of the axles, as discussed herein. The present invention includes a vehicle or trailer that includes one or more generators disposed within the wheels of the vehicle and/or one or more generators disposed or included on one or more of the axles of the vehicle. Wherein power is generated by the rotation of the wheels and axles and the power is used to charge one or more batteries located on the vehicle and/or trailer.

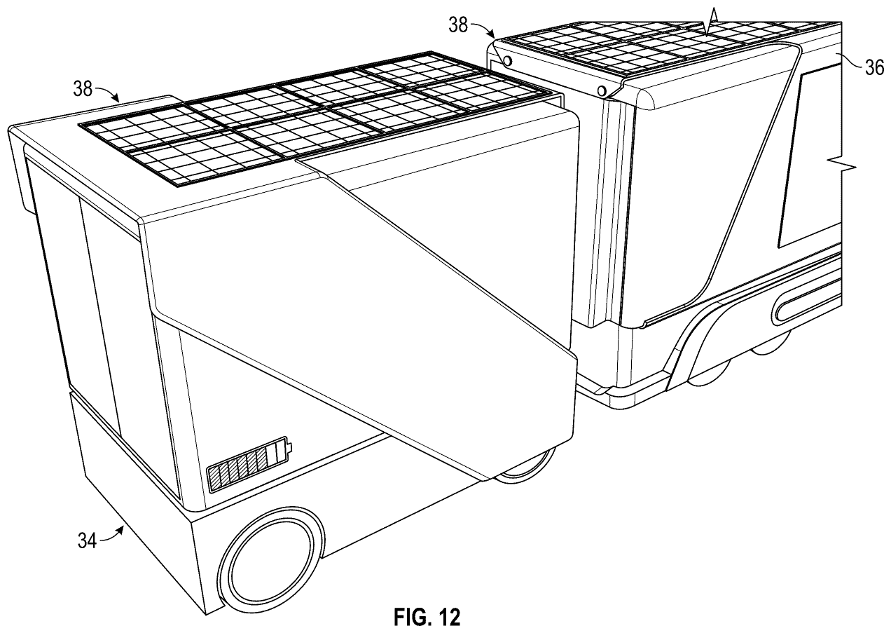

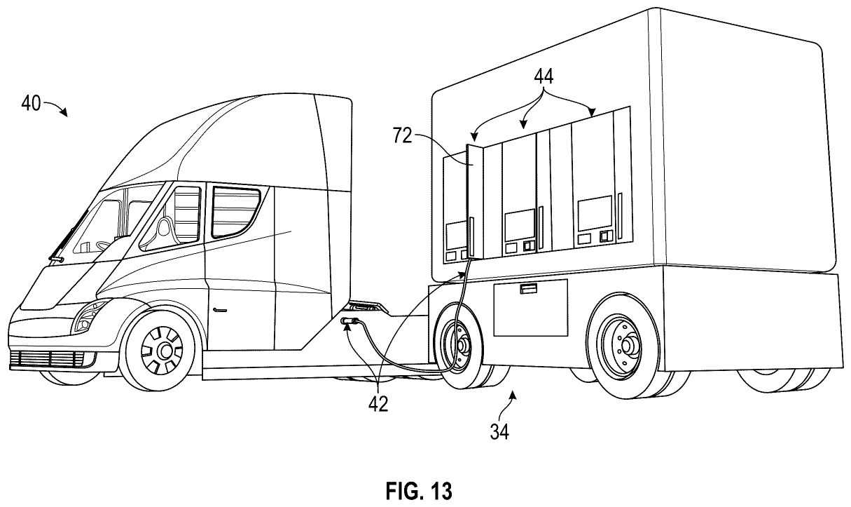

FIGS. 12-13 show another preferred embodiment of the present invention that includes a charging trailer 34 that may be used or towed by a semi-truck. FIG. 12 shows a charging trailer 34 connected to a semi-truck trailer 36. The charging trailer 34 is shown as a small trailer (compared to the regular box trailer on a semi-truck) that connects to a semi-truck or semi-truck trailer 36 and charges as it moves (the batteries thereon or therein charge). This type of charging trailer 34 may be used for cities, town, facilities, warehouses, businesses or other locations that need power, want to reduce dependence on the regular electrical grid and/or want to be independent. This provides another option for charging or providing power to one or more batteries onboard the charging trailer 34 while the semi-truck travels from location to location along a route. The charging trailers 34 include onboard charging of the batteries via generators or other smart charging systems located on the axle(s) and/or associated with or in the wheel(s)/rim(s) and that are electrically connected to the associated batteries located on or in the trailer. Similar to the battery assemblies 10 discussed herein, one or more charging trailers 34 may be dropped off at a first location to provide power at the first location and one or more further charging trailers 34 may subsequently be towed to and dropped off at a second location. The charging trailer 34 includes one or more generators onboard for charging or powering the one or more batteries located onboard the charging trailer 34. The generators may be located in the wheels, on the axles or anywhere desired and are charged as the charging trailer 34 travels over the road from location to location. As shown in FIG. 12, one or both of the charging trailer 34 and the semi-truck trailer 36 may include solar panels 38 thereon that are electrically connected to or communicated with the onboard batteries to provide further charging while the semi-truck travels over the route and also while the semi-truck is stationary.

FIG. 13 shows the cab 40 of a semi-truck being charged by a charging trailer 34. The charging trailer 34 (which includes batteries that have been charged, which may be referred to herein as charging batteries) may include separate charging stations 44 that each include a separate cord or cable 42 for connecting to and charging an electrical vehicle, such as the cab 40 shown in FIG. 13. Note the open door 72 from which the cable 42 extends associated with one of the charging stations 44. The electric vehicle (e.g., cab 40) includes a powering battery therein that is charged by the charging battery. It will be appreciated that this may allow the ability to provide charging stations at any desired location and along pre-defined or predetermined regular routes used for freight delivery. This essentially provides power or charging stations (think “gas stations”) for charging electric vehicles throughout the country, where the power is supplied by battery assemblies 10 or charging trailers 34 that have been charged by a vehicle moving between locations.

It will be appreciated that the charging trailers 34 are trailers that include or are essentially portable batteries with built in generators that are operated by the rotation of the wheels and that power onboard batteries. As long as the wheels are spinning, the batteries are charging. In a preferred embodiment, the charging trailers are designed to piggyback on or utilize the existing trucking or freight industry, with no need for additional trucks. The batteries may be second life, recycled EV batteries that, after being charged may provide enough power to power the average house for a month. As a result, this creates “mini grids,” the ability to deliver energy or power to remote, power scarce locations, creates EV power charging stations and the ability to provide power during national disasters, e.g., delivering power to areas struck by hurricanes, earthquakes, etc.

As will be appreciated by those of ordinary skill in the art, within the shipping and freight industry, containers containing goods are delivered to ports on ships. The containers are unloaded from the ships and placed on trucks that include a chassis on which the containers are secured. The containers full of goods are delivered to a warehouse proximate to the port (e.g., a “port warehouse”) and the goods are unloaded. The empty containers are then returned to the port by the chassis trucks. The goods are then loaded on or in dry vans, semi-trucks or box trucks, which transport the goods to their final destination or location. This process may be referred to as the distribution network. In a preferred embodiment, the smart charging trailer system 112 may be included on any of the trucks (chassis/container truck or dry/box truck) within the distribution network.

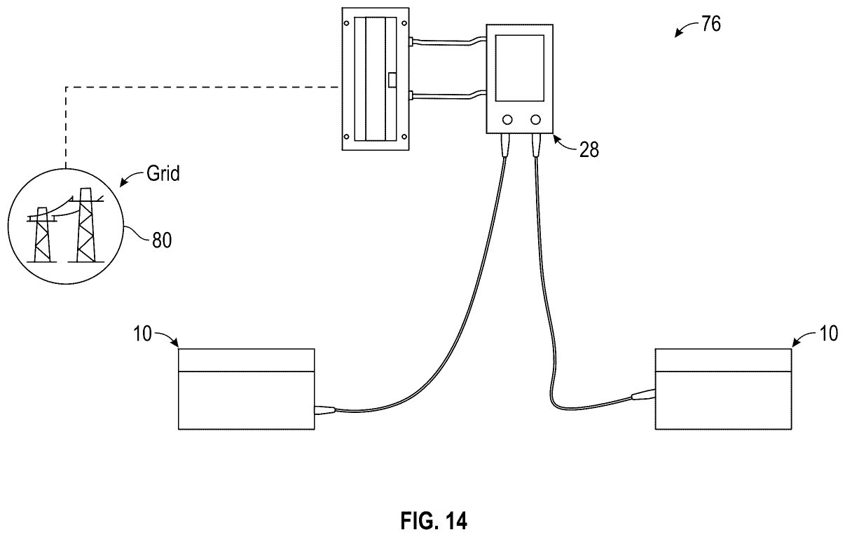

As shown in FIG. 14, a warehouse 76, other building or location where a battery assembly or other battery or batteries 10 that have been recharged via a semi-truck traveling along a route and delivered to the warehouse (i.e., charging batteries) may be connected to an electrical box 28 that allows switching between power from the battery assembly 10 and power from the grid 80. The electrical box may be connected to powering batteries, which are batteries in an electrical component, such as a mobile phone. This allows the warehouse 76 or other location to utilize battery power (from the batteries 10 charged by the system described herein) when available and lessens the demand on the power grid 80. In a preferred embodiment, where the warehouse or location is along a route that is traveled regularly by delivery semi-trucks, a semi-truck may drop off a fully charged first battery assembly 10 and/or first charging trailer 34 to provide power to the first warehouse (or to electric vehicles, as shown in FIG. 13) and pick up or load a depleted second battery assembly into the trailer of the semi-truck and/or connect a second charging trailer. The second battery assembly may then be electrically connected to the charging system of the semi-truck, such that the second battery assembly and/or second charging trailer is recharged as the semi-truck travels to another warehouse or second location and drops the second battery assembly off to power the second location. This can be repeated based on regular delivery or freight hauling schedules. In another embodiment, instead of dropping off pallet batteries or battery assemblies at each location, the semi-truck may pull or tow a connected battery trailer to each location and pick up depleted battery trailers, as discussed above with respect to the battery assemblies. Based on hundreds or thousands of freight trucks traveling throughout the country on a daily basis, an entire system or grid of power can be created or provided to power electric vehicles, buildings or anything desired to be powered. The key is charging batteries as the semi-trucks or other vehicles move from location to location.

The vehicle may also be a train that tows a charging car or trailer as part of the train. Other exemplary vehicles for towing charging trailers 34, may include, for example, buses, semi-trucks, military vehicles, trains, etc. The train trailer or car may be referred to herein as an e-wagon, which are freight train wagons that generate power as they move from town to town or location to location along the rails, supplying electricity via the batteries on the wagons that are charged as the train moves and the axles rotate.

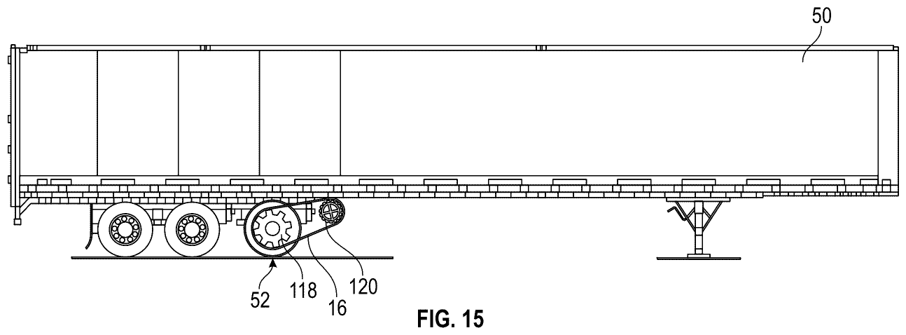

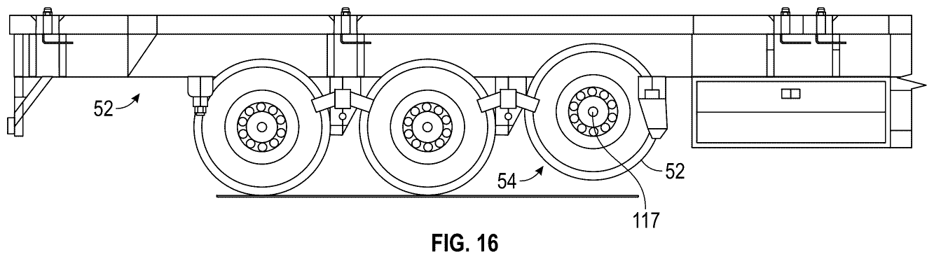

FIGS. 15 and 16 show further preferred embodiments of the present invention where a trailer 50 includes at least one dummy wheel, set of wheels or axle (all designated 52 herein) that's main purpose is to generate power to be store in one or more onboard batteries. FIG. 15 shows a dummy wheel 52 that is associated with or connected to a generator 114 via a chain, belt 16 or the like and the rotation of the wheel is used to generate power or electricity through the generator. In a preferred embodiment, the dummy wheel 52 may not include any brakes and can be retrofit on an existing trailer (that typically includes two axles and sets of wheels). However, this is not a limitation. As discussed herein, the generator can be used to charge a battery, such as a pallet battery located in the storage portion of the trailer. The wheel(s) or axle may be referred to herein as a “third” or “dummy” wheel or axle because many existing trailers include two axles (e.g., two drive axles) at the back thereof, as shown in FIG. 15.

FIG. 16 shows another embodiment of a trailer 50 with a third or e-axle 52 that is used for charging the batteries via a generator (preferably located onboard or otherwise associated with the axle) as a result of the rotation of the one or more wheels on the axle. In the embodiment of FIG. 16, the e-axle 52 includes a lift system 54 (e.g., a hydraulic lift system) that can be used to raise or lift the wheels of the e-axle or dummy axle 52 off the ground, when desired. The lift system can be any type of system that lifts or raises the wheels and/or tires associated with the charging system or assembly off of the ground.

The wheels or tires may be lifted off the road or ground due to adverse road conditions or if the battery, batteries or system are fully charged. The tires may also be lowered back down to the ground when desired (e.g., when there are no longer adverse road conditions). The raising and lowering between a first position where the wheels are in contact with the ground (and are thus rolling or rotating) and a second where the wheels are not in contact with the ground (and are thus not rolling or rotating) may be done at intervals, in an automated routine or in any other pattern or timing as desired. FIG. 16 shows the tire and/or wheel off the ground or in a second position after being lifted by the lift system.

It will be appreciated that the present invention is not limited to trailers for semi-trucks/trailers, but can be used or incorporated into any vehicle and, in particular, any vehicle that includes an axle or other rotating shaft or component, such as trains, cars, buses, tractors, cabs and the like.

In a preferred embodiment of the present invention, at least a portion of the functionality of the inventions, embodiments, concepts and disclosure herein is implemented as software executing on a server that is in connection, via a network, with other portions of the system, including databases and external services. The server comprises a computer device capable of receiving input commands, processing data, and outputting the results for the user. Preferably, the server consists of RAM (memory), hard disk, network, central processing unit (CPU). It will be understood and appreciated by those of skill in the art that the server could be replaced with, or augmented by, any number of other computer device types or processing units, including but not limited to a desktop computer, laptop computer, mobile or tablet device, or the like. Similarly, the hard disk could be replaced with any number of computer storage devices, including flash drives, removable media storage devices (CDs, DVDs, etc.), or the like.

The network can consist of any network type, including but not limited to a local area network (LAN), wide area network (WAN), and/or the internet. The server can consist of any computing device or combination thereof, including but not limited to the computing devices described herein, such as a desktop computer, laptop computer, mobile or tablet device, as well as storage devices that may be connected to the network, such as hard drives, flash drives, removable media storage devices, or the like.

The storage devices (e.g., hard disk, another server, a NAS, or other devices known to persons of ordinary skill in the art), are intended to be nonvolatile, computer readable storage media to provide storage of computer-executable instructions, data structures, program modules, and other data for the mobile app, which are executed by CPU/processor (or the corresponding processor of such other components). The various components of the present disclosure may be stored or recorded on a hard disk or other like storage devices described above, which may be accessed and utilized by a web browser, mobile app, the server (over the network), or any of the peripheral devices described herein. One or more of the modules or steps of the present disclosure also may be stored or recorded on the server, and transmitted over the network, to be accessed and utilized by a web browser, a mobile app, or any other computing device that may be connected to one or more of the web browser, mobile app, the network, and/or the server.

References to a “database” or to “database table” are intended to encompass any system for storing data and any data structures therein, including relational database management systems and any tables therein, non-relational database management systems, document-oriented databases, NoSQL databases, or any other system for storing data.

Software and web or internet implementations of the present disclosure could be accomplished with standard programming techniques with logic to accomplish the various steps in accordance with the present disclosure described herein. It should also be noted that the terms “component,” “module,” or “step,” as may be used herein, are intended to encompass implementations using one or more lines of software code, macro instructions, hardware implementations, and/or equipment for receiving manual inputs, as will be well understood and appreciated by those of ordinary skill in the art. Such software code, modules, or elements may be implemented with any programming or scripting language such as C, C++, C#, Java, Cobol, assembler, PERL, Python, PHP, or the like, or macros using Excel or other similar or related applications with various algorithms being implemented with any combination of data structures, objects, processes, routines or other programming elements.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof, means any connection or coupling, either direct or indirect, between two or more elements; the coupling of connection between the elements can be physical, logical, or a combination thereof. Additionally, the words “herein,” “above,” “below,” and words of similar import, when used in this application, shall refer to this application as a whole and not to any particular portions of this application. Where the context permits, words in the above Detailed Description of the Preferred Embodiments using the singular or plural number may also include the plural or singular number respectively. The word “or” in reference to a list of two or more items, covers all of the following interpretations of the word: any of the items in the list, all of the items in the list, and any combination of the items in the list.

The above-detailed description of embodiments of the disclosure is not intended to be exhaustive or to limit the teachings to the precise form disclosed above. While specific embodiments of and examples for the disclosure are described above for illustrative purposes, various equivalent modifications are possible within the scope of the disclosure, as those skilled in the relevant art will recognize. Further, any specific numbers noted herein are only examples: alternative implementations may employ differing values, measurements or ranges.

Although the operations of any method(s) disclosed or described herein either explicitly or implicitly are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

The teachings of the disclosure provided herein can be applied to other systems, not necessarily the system described above. The elements and acts of the various embodiments described above can be combined to provide further embodiments. Any measurements or dimensions described or used herein are merely exemplary and not a limitation on the present invention. Other measurements or dimensions are within the scope of the invention.

Any patents and applications and other references noted above, including any that may be listed in accompanying filing papers, are incorporated herein by reference in their entirety. Aspects of the disclosure can be modified, if necessary, to employ the systems, functions, and concepts of the various references described above to provide yet further embodiments of the disclosure.

These and other changes can be made to the disclosure in light of the above Detailed Description of the Preferred Embodiments. While the above description describes certain embodiments of the disclosure, and describes the best mode contemplated, no matter how detailed the above appears in text, the teachings can be practiced in many ways. Details of the system may vary considerably in its implementation details, while still being encompassed by the subject matter disclosed herein. As noted above, particular terminology used when describing certain features or aspects of the disclosure should not be taken to imply that the terminology is being redefined herein to be restricted to any specific characteristics, features or aspects of the disclosure with which that terminology is associated. In general, the terms used in the following claims should not be construed to limit the disclosures to the specific embodiments disclosed in the specification unless the above Detailed Description of the Preferred Embodiments section explicitly defines such terms. Accordingly, the actual scope of the disclosure encompasses not only the disclosed embodiments, but also all equivalent ways of practicing or implementing the disclosure under the claims.

While certain aspects of the disclosure are presented below in certain claim forms, the inventors contemplate the various aspects of the disclosure in any number of claim forms. For example, while only one aspect of the disclosure is recited as a means-plus-function claim under 35 U.S.C. § 112, 16, other aspects may likewise be embodied as a means-plus-function claim, or in other forms, such as being embodied in a computer-readable medium. (Any claims intended to be treated under 35 U.S.C. § 112, 16 will include the words “means for”). Accordingly, the applicant reserves the right to add additional claims after filing the application to pursue such additional claim forms for other aspects of the disclosure.

Accordingly, although exemplary embodiments of the invention have been shown and described, it is to be understood that all the terms used herein are descriptive rather than limiting, and that many changes, modifications, and substitutions may be made by one having ordinary skill in the art without departing from the spirit and scope of the invention.

What is claimed is:

1. A method of charging batteries comprising the steps of:
moving a first vehicle from a first location to a second location, wherein the vehicle includes at least a first charging battery associated therewith, wherein the first charging battery is charged via the rotation of at least a first wheel as the first vehicle moves from the first location to the second location,
leaving the first charging battery at the second location, wherein the first charging battery is used at the second location to charge a first powering battery,
associating a second charging battery with the first vehicle,
moving the first vehicle from the second location to a third location, wherein the second charging battery is charged via the rotation of the first wheel as the first vehicle moves from the second location to the third location, and
leaving the second charging battery at the third location, wherein the second charging battery is used at the third location to charge a second powering battery.

2. The charging system of claim 1 wherein the first vehicle includes a charging assembly associated with an axle of the vehicle.

3. The charging system of claim 1 wherein the first charging battery is associated with a first battery assembly that includes a footprint that is approximately the size of a standard pallet footprint, and wherein the first battery assembly is positioned in a trailer interior of a trailer of the vehicle.

4. The charging system of claim 3 wherein the trailer interior includes one or more standard pallets therein that include goods being moved from the first location.

5. The charging system of claim 1 wherein the first vehicle is a semi-truck that includes a first cab and a first trailer, wherein the first charging battery is associated with a charging trailer that is connected to the first trailer.

6. The charging system of claim 1 wherein the first powering battery is used to charge an electric vehicle.

7. The charging system of claim 1 wherein the first powering battery is used to charge a building.

8. The charging system of claim 2 wherein the axle does not include brakes.

9. The charging system of claim 2 wherein the axle includes a lift system that is configured to move the axle and first wheel between a first position where the first wheel contacts the ground and a second position where the first wheel does not contact the ground.

10. A battery charging system configured to be used with a vehicle, the charging system comprising:
an axle having at least a first wheel thereon,
a first gear associated with the axle,
a second gear associated with a generator, wherein a belt extends between the first gear and the second gear, wherein the generator is electrically connected to a first battery, wherein rotation of the first wheel causes rotation of the first gear, the belt and the second gear, and wherein rotation of the second gear causes the generator to charge the first battery.

11. The battery charging system of claim 10 wherein the axle includes a torque converter.

12. The battery charging system of claim 10 wherein the vehicle is a semi-truck that includes a first cab and a first trailer, wherein the first battery is positioned in a trailer interior of the first trailer.

13. The battery charging system of claim 12 wherein the first battery is associated with a first battery assembly that includes a footprint that is approximately the size of a footprint of a standard pallet.

14. The battery charging system of claim 10 wherein the vehicle is a semi-truck that includes a first cab and a first trailer, wherein the first battery is associated with a charging trailer that is connected to the first trailer.

15. The battery charging system of claim 10 wherein the vehicle is a semi-truck that includes a first cab and a first trailer, wherein the first battery is a powering battery that powers the cab of the semi-truck.

16. The battery charging system of claim 12 wherein a second battery is positioned in the trailer interior, wherein the first trailer includes a charging track that is in electrical communication with the first and second batteries and the battery charging system.
